(19) United States
(12) Patent Application Publication
(10) Pub. No.: US 2013/0223958 A1
(43) Pub. Date: Aug. 29, 2013

(54) MATERIAL HANDLING APPARATUS

(71) Applicant: Paul Cummings, Bicester (GB)

(72) Inventor: Paul Cummings, Bicester (GB)

(73) Assignee: Blue Sky Access Ltd.

(21) Appl. No.: 13/820,836

(22) PCT Filed: Sep. 6, 2011
(86) PCT No.: PCT/GB2011/001301

§ 371 Date: May 15, 2013

(30) Foreign Application Priority Data
Sep. 8, 2010 (GB) 1014920.1

(51) Int. Cl. E04G 21/16; B62D 33/02

(52) U.S. Cl. CPC E04G 21/163; B62D 33/02
USPC 414/10; 296/184.1

(57) ABSTRACT

An aerial lift (10) having a platform (12) surrounded by a kick plate (14) adjacent the platform with a pair of spaced apart cross members (22) supported on the kick plate and extending transversely of the platform, each cross member (22) being secured to the kick plate (14) by engaging with the kick plate on opposite sides of the platform (12) and having an upwardly projecting stop (26) at each end thereof for sideways location of material(s) D supported on the cross members (22).

### CROSS-REFERENCE TO RELATED PATENT APPLICATIONS

This application is a national stage of PCT Application No. PCT/GB2011/001301, filed Sep. 6, 2011, which claims priority to United Kingdom Priority Application 1014920.1 filed Sep. 8, 2010. The specification, drawings, claims and abstract of these applications, are incorporated herein by reference in their entirety.

### FIELD

This invention relates to material handling apparatus in particular but not necessarily for the moving lengths of ducting and in particular ducting used during construction of buildings.

### BACKGROUND OF THE INVENTION

Building construction sites for large buildings frequently employ construction equipment for lifting large and heavy components into position during the construction of a building. For example, lengths of standard ducting may be up to 2.9 meters in length and up to 2.1 meters×2.5 meters in section and weigh up to 350 kgs. During construction of commercial building the overhead ducting is typically lifted and fixed into position using manned aerial lifts which may be provided with material handling apparatus to facilitate the final positioning of the ducting.

A typical aerial lift is a mobile scissor lift available from JLG Ind. and which has a work platform which may be lifted into the air by a hydraulically operable scissor mechanism. For safety the work platform is surrounded by a safety barrier or fence for the protection of personnel on the platform.

The present invention provides an aerial lift adapted for the handing of ducting.

### STATEMENTS OF INVENTION

According to a first aspect of the present invention there is provided an aerial lift having a platform surrounded by a kick plate adjacent the platform with a pair of spaced apart cross members supported on the kick plate and extending transversely of the platform, each cross member being secured to the kick plate and having an upwardly projecting stop at each end thereof for sideways location of material(s) supported on the cross members.

Typically the lift is intended for moving length of rectangular or square section materials such as ducting but could be utilised for moving other objects that will fit onto the cross members between the stops.

The cross members are held in place by engaging with the kick plate on opposite sides of the platform and are held in a stable condition resting on the platform.

Preferably the cross members have a bracket at each end portion thereof for coupling to a respective second bracket standing on the platform and engaging with the kick plate. The kick plate on an aerial lift typically has an upper edge with either an inwardly or an outwardly turned lip which may be further provided with a downwardly turned lip flange. The second bracket used in co-operation with the kick plate may be adapted to engage with the different kick-plates.

Preferably the stops at the end of the cross-members are adjustably connected to the cross members for accommodating different widths of material(s) e.g. ducting.

Preferably a pair of spaced apart longitudinal beams are supported on the cross-members and extend beyond the platform for insertion into ducting, or other hollow object, for lifting an manoeuvring the ducting. The beams are adjustably mounted on the cross members to accommodate different widths of ducting. The distal ends of the two beams are coupled together by a transverse connecting rod.

### DESCRIPTION OF THE DRAWINGS

The invention will be described by way of example and with reference to the accompanying drawings in which:

FIG. 1 is a side elevation of an aerial lift and platform with a duct mounted in situ thereon.

FIG. 2 is an exploded isometric view of the kick plate and duct carrying assembly according to the present invention,

FIG. 3 is an isometric view of a cross beam and associated brackets as are used FIG. 2, and

FIG. 4 is an exploded isometric view of the kick plate and duct carrying assembly as shown in FIG. 2 having the longitudinal beams thereon for insertion into ducting for lifting and carrying.

### DETAILED DESCRIPTION OF THE INVENTION

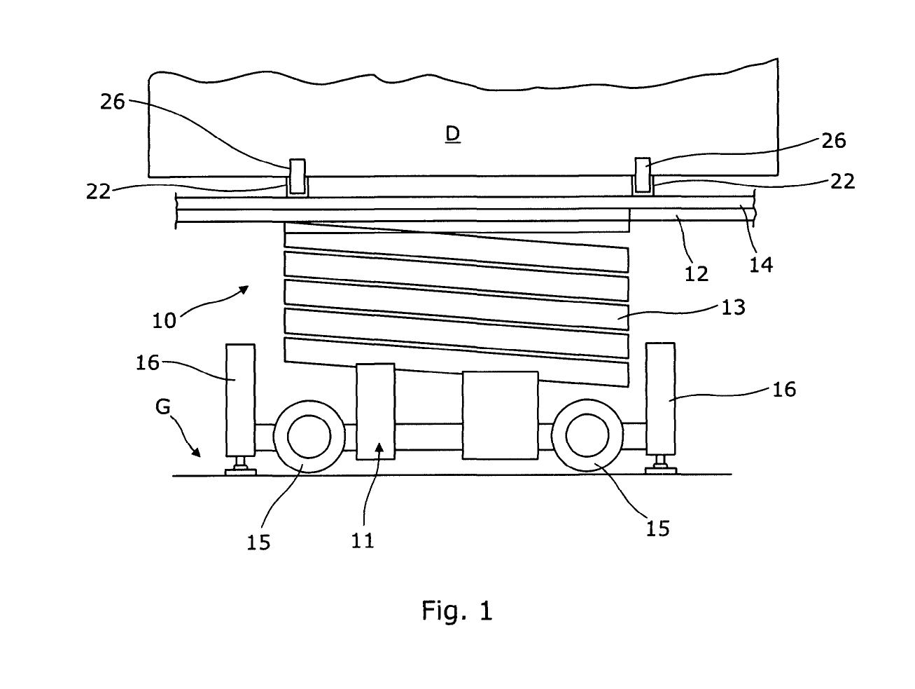

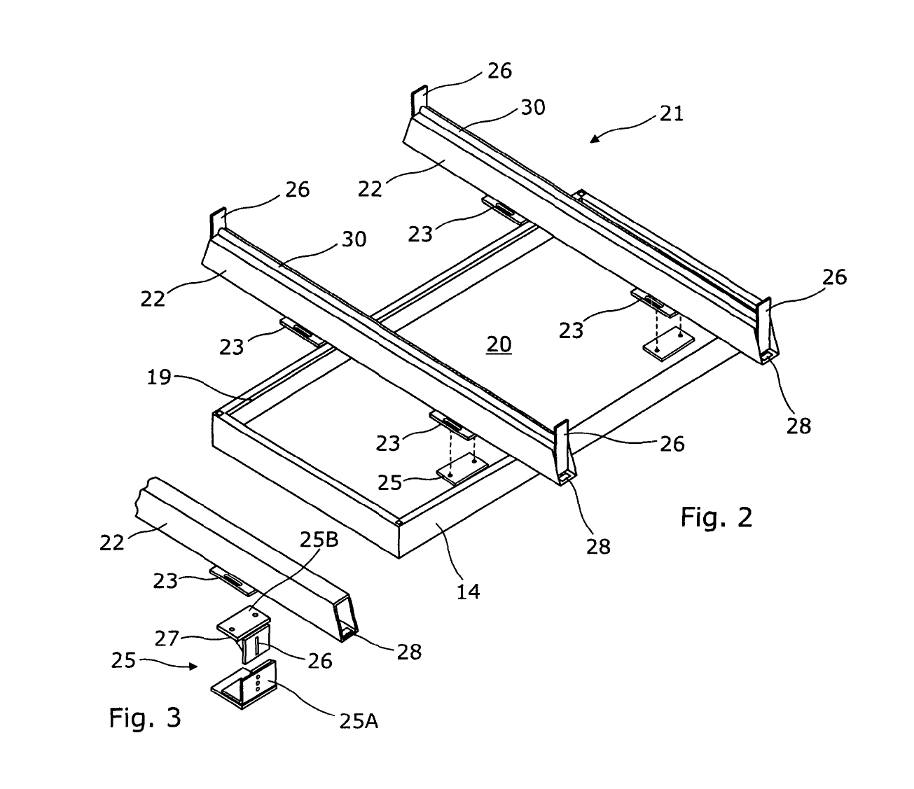

FIG. 1 shows an aerial lift 10 in the form of a self drive mobile scissor lift available from Genie, a suitable lift being a Genie 26/46 scissor with the safety barrier removed. The lift 10 has a drivable vehicle body 11 having wheels 15 and a work platform 12 located on its body and which in use can be raised or lowered relative to the ground G. The platform 12 is shown in a lowered condition and the vehicle body is provided with stabilisers 16 at its corners which are lowered to provide stability during use of the lift. The work platform 12 is raised or lowered by a scissor type mechanism 13 typically operated by a powered hydraulic system provided on the lift. The platform 12 is provided with a kick plate 14 adjacent the platform 12. The kick plate 14 typically has an upper edge with an inwardly and downwardly turned lip 19 (see FIG. 2). The aerial lift may be controlled and operated via a remote controller so that no personnel are required on the platform at any time during use.

With reference also to FIGS. 2 to 4, there is shown a duct carrying assembly 21 mounted on the kick plate 14 of the work platform 12. The duct carrier assembly 21 comprises at least two spaced apart cross beams 22 which extend across the platform 12 and rest on top of the lip 19 of the kick plate 14.

The cross beams 22 are held in place on the kick plate 14 by two spaced apart brackets 23 secured to the cross members by for example welding and which is are each fastened to a respective pair of further brackets 25 arranged on the platform floor 20 adjacent the kick plate 14. Each pair of further brackets 25 comprise a lower “L” shaped bracket 25A which sits on the platform floor 20 with its back against the kick plate 14, and an upper “L” shaped bracket 25B which in use engages under the lip 19 of the kick plate 14. The two brackets 25 A & B are mounted back to back with the upper bracket inverted and having an elongate aperture 26 in its back whereby it is adjustably mounted on the lower bracket 25A using suitable fasteners. The upper bracket 25A has a detent 27 on its upper surface which is engagable with the kick plate 14 to hold the pair of brackets on the platform.

Each cross member 22 is secured to the kick plate 14 by respective brackets 23 & 25 on the opposite sides of the platform. The cross members 22 are hollow and the ends of the cross-members 22 are provided with safety stops 26 which extend upwardly to facilitate location of ducting D mounted on the cross members 22. The stops 26 may be detachably and adjustably mounted within the hollow cross members to facilitate use with different sizes of ducting. A length of tubing 30 or semi circular section tube may be provided on the upper surface of the cross members 22 to provide point contact with the ducting D to facilitate longitudinal movement of the ducting D when mounted on the carrier assembly 21. The outer end portions of the cross beams are inclined inwardly from the base to provide access to apertures 28 in the end portions of the cross members which are provided as anchorage points for safety straps.

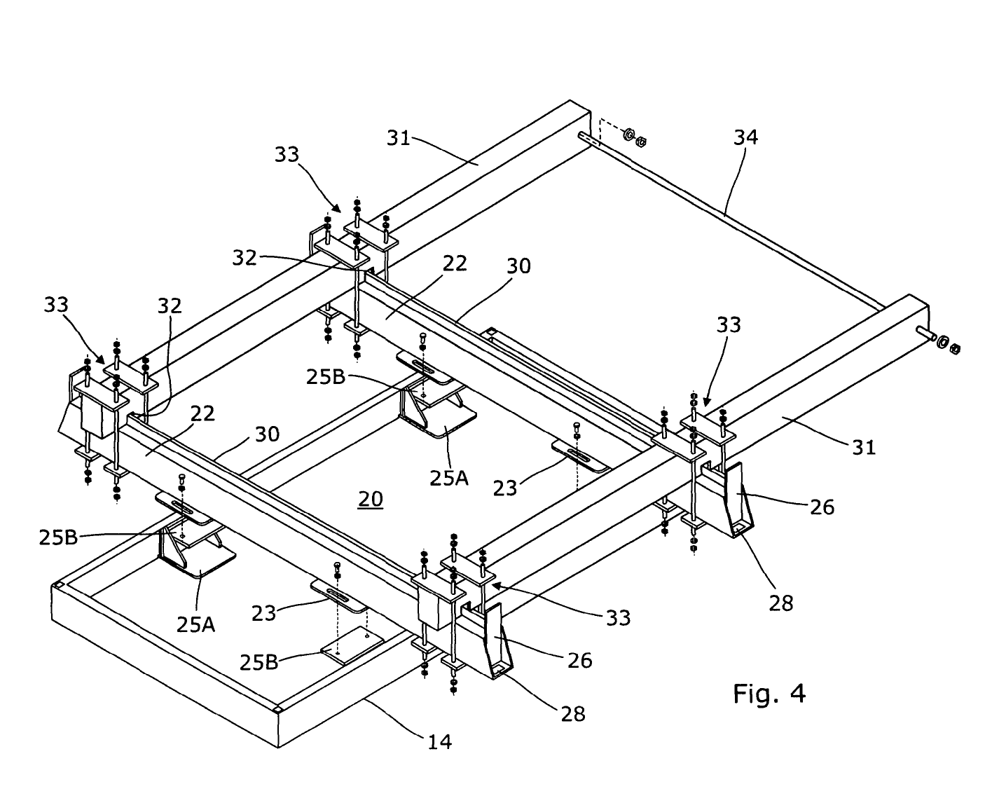

With reference to FIG. 4 there is shown the ducting carrier assembly 21 which is further provided with a pair of spaced apart longitudinally extending beams 31 which are mounted on the upper surface of the cross members 22. The undersides of the longitudinal beams are provided with cut-outs 32 to accommodate the tubes 27 and are secured in place by releasable clamps 33. The clamps 33 may be undone to permit repositioning of the longitudinal beams 32 if required or desired.

The two longitudinal beams 32 extend outwardly in one direction beyond the platform 12 to form a fork which can be inserted into a duct, or other hollow object, for lifting and carrying in the manner of a fork lift. The releasable clamps 33 allow the beams to be moved relative to each other to accommodate different widths of ducting. The distal ends of the beams 32 are connected together by a rod 34 which serves to strengthen the fork and also prevent the beams 32 from passing to the outside of a duct during insertion.

Typically the lift is intended for moving length of rectangular or square section ducting D as described above. However such a lift could be utilised for moving other objects that will fit onto the cross members between the stops, for example heat exchanger units, or fan units.

1. An aerial lift having a platform surrounded by a kick plate adjacent the platform, wherein
said aerial lift comprises a pair of spaced apart cross members mounted on the kick plate and extending across the platform,
each cross member being secured to the kick plate on opposite sides of the platform, and
each cross member having an upwardly projecting stop at each end thereof for facilitating location of an object supported on the spaced apart cross members.

2. An aerial lift as claimed in claim 1, wherein each cross member is secured to the kick plate by a pair of brackets on each opposite sides of the platform.

3. An aerial lift as claimed in claim 2, wherein each cross members has an upper bracket at each end portion thereof coupled to a respective lower bracket standing on the platform and engaging with the kick plate.

4. An aerial lift as claimed in claim 1, wherein the upwardly projecting stops at the ends of each cross-members are adjustably connected to the cross members for accommodating different sizes of object.

5. An aerial lift as claimed in claim 1, further comprising a pair of spaced apart longitudinal beams mounted on the cross members and extending beyond the platform, to the same side of the platform, for insertion into hollow objects for lifting and manoeuvring said hollow objects.

6. An aerial lift as claimed in claim 5, wherein the longitudinal beams are adjustably mounted on the cross members for accommodating different sizes of hollow object.

7. An aerial lift as claimed in claim 5, wherein the distal ends of the pair of spaced apart longitudinal beams are coupled together by a transverse connecting rod.

8. An aerial lift as claimed in claim 1, for the transport of lengths of ducting.

9. An aerial lift as claimed in claim 3, wherein said upper bracket is adjustably coupled to the respective lower bracket.

10. An aerial lift as claimed in claim 1, wherein the end portions of each cross member define an aperture for providing an anchorage point for a safety strap.

11. An aerial lift as claimed in claim 10, wherein each cross member is a beam having a U-shaped section and the apertures are defined in the base of the U-shaped section.

12. An aerial lift as claimed in claim 11, wherein the side walls of the end portions of each cross member are inclined inwardly for facilitating access to the apertures.

13. Carrier apparatus for an aerial lift having a platform surrounded by a kick plate adjacent the platform, said carrier apparatus comprising:
a pair of cross members for mounting on the kick plate of the aerial lift such that the cross members extend across the platform at spaced apart locations, each cross member having a safety stop at each end thereof;
an upper bracket at each end portion of each cross member, and
a respective lower bracket for each upper bracket, said lower bracket configured to stand on the platform and engage with the kick plate of the aerial lift;
said upper brackets of each cross member and respective lower brackets for securing the cross member to the kick plate on opposite sides of the platform.

14. Carrier apparatus as claimed in claim 13, wherein the safety stops at the ends of each cross-member are adjustably connected to the cross member.

15. Carrier apparatus as claimed in claim 13, further comprising a pair of longitudinal beams for mounting on the cross members such that the longitudinal beams extend beyond the platform, to the same side of the platform.
